(19) United States
(12) Patent Application Publication
(10) Pub. No.: US 2012/0041809 A1
(43) Pub. Date: Feb. 16, 2012

(54) METHOD FOR INTEGRATING ONLINE AND OFFLINE VIRTUAL MONEY WITH AN ELECTRONIC GIFT CERTIFICATE, AND SYSTEM FOR SAME

(76) Inventor: Bo Hyun Park, Seoul (KR)

(21) Appl. No.: 13/265,458

(22) PCT Filed: Apr. 19, 2010
(86) PCT No.: PCT/KR2010/002431

§ 371 Date: Oct. 20, 2011

(30) Foreign Application Priority Data
Apr. 22, 2009 (KR) 10-2009-0035055

(51) Int. Cl. G06Q 30/02

(52) U.S. Cl. 705/14.17

(57) ABSTRACT

The present invention relates a method for integrating on-line and off-line virtual currency into electric gift certificates. The present invention includes a step of receiving an identifying ID and an identifying authentication number of a business member providing virtual currency, and a reference denomination value of the virtual currency, a step of generating an electric gift certificate having the reference denomination value of the virtual currency, a step of sending a unique identification number of the generated electric gift certificate, a step of receiving a identification number of an owner to whom the electric gift certificate is to be sent, and a step of recording the identification number of the owner of the electric gift certificate and sending the generated electric gift certificate to the owner of the electric gift certificate.

### TECHNICAL FIELD

The present invention relates to method for integration of electric gift vouchers and system thereof. More particularly, the present invention relates to method for integrating on-line and off-line virtual currency into electric gift vouchers and the system thereof.

### BACKGROUND ART

The present invention relates to method for integrating on-line and off-line virtual currency into electric gift vouchers and the system thereof.

Today, varying types of virtual currency are issued within on-line and off-line environments, with which numerous transactions are processed. Specifically, along with the conventional gift certificates, customers are provided with points according to trade record over on-line environment in which the customers can pay the bill with the points as nearly the same as legal tender. Although different types of virtual money, which have similar functions though, are being introduced, they have problems to limit their usage, because they are fragmented into small values.

### DISCLOSURE

### Technical Problem

Therefore, as being contrived to address the above-mentioned conventional problems, purpose of the present invention is to provide method for integrating on-line virtual currency into electric gift vouchers and the system thereof.

Further, another purpose of the present invention is to provide method for integrating off-line virtual currency into electric gift vouchers and the system thereof.

Further, yet another purpose of the present invention is to provide method for converting different types of virtual currency based on a reference denomination, integrating them into a unified type of electric gift certificate and using it, and system thereof.

Furthermore, yet another purpose of the present invention is to provide method for facilitating issuance and usage of electric gift certificates to stimulate transactions using the electric gift certificates and system thereof.

### Technical Solution

According to characteristics of the present invention for accomplishing the above mentioned purposes, the present invention may include a step of receiving an identifying ID and an identifying authentication number of a business member providing virtual currency, and a reference denomination value of the virtual currency, a step of generating an electric gift certificate having the reference denomination value of the virtual currency, a step of sending a unique identification number of the generated electric gift certificate, a step of receiving a identification number of an owner to whom the electric gift certificate is to be sent and a step of recording the identification number of the owner of the electric gift certificate and sending the generated electric gift certificate to the owner of the electric gift certificate.

The step of receiving a identification number of an owner to whom the electric gift certificate is to be sent may include receiving the identification number of the owner to whom the electric gift certificate is to be sent and the unique identification number of the electric gift certificate.

When the electric gift certificate is previously registered with the identification number of the owner to whom the electric gift certificate is to be sent, the method may include a step of updating a nominal value of the previously registered electric gift certificate with a value adding up a nominal value of the generated electric gift certificate, and sending the updated electric gift certificate to the owner of the electric gift certificate.

Further, according to desirable one embodiment of the present invention for accomplishing the above mentioned purposes, the present invention may include a business member information interface for receiving an identifying ID and an identifying authentication number of a business member providing virtual currency, and a reference denomination value of the virtual currency, an ownership information interface for receiving a identification information of an owner to whom an electric gift certificate is to be sent, an electric gift certificate manager for generating and updating the electric gift certificate having the reference denomination value of the virtual currency, an electric gift certificate storage for storing the generated and updated by the electric gift certificate manager and an electric gift certificate sender for sending the electric gift certificate to the owner of the electric gift certificate.

The electric gift certificate may include at least one among a serial number, a bar code, or an authentication number.

The identification information of the owner may include a mobile communication identification number of the owner, and the electric gift certificate sender may send the electric gift certificate to a mobile communication terminal corresponding to the mobile communication identification number of the owner in connection with an MMS server or an SMS server of a mobile communication system.

The business member information interface and the ownership information interface may be externally presented as API type of modules.

### Advantageous Effects

According to the above description, the present invention may unify varying types of on-line virtual currency into a common electric gift certificate.

Further, the present invention may integrate varying types of off-line virtual currency into a common electric gift certificate.

Further, the present invention may convert varying types of virtual currency based on reference denomination and integrate them into a common type of electric gift certificate to use.

Further, the present invention may facilitate compensation system of business members for their customers and provide the contractors with convenient interfaces for the system.

### DESCRIPTION OF DRAWINGS

FIG. 1 is a flow chart illustrating method of integrating on-line and off-line virtual currency into an electric gift certificate according to embodiments of the present invention.

FIG. 2 is a block diagram illustrating a system for integrating on-line and off-line virtual currency into an electric gift certificate according to embodiments of the present invention.

FIG. 3 is a conceptual figure illustrating an electric gift certificate, into which on-line and off-line virtual currency are integrate, shown on a mobile telecommunication terminal.

### MODE FOR INVENTION

Hereinafter, advantageous embodiments of the method for integrating on-line and off-line virtual currency into electric gift vouchers and the system thereof according to the present invention are described in detail with reference to the accompanying drawings.

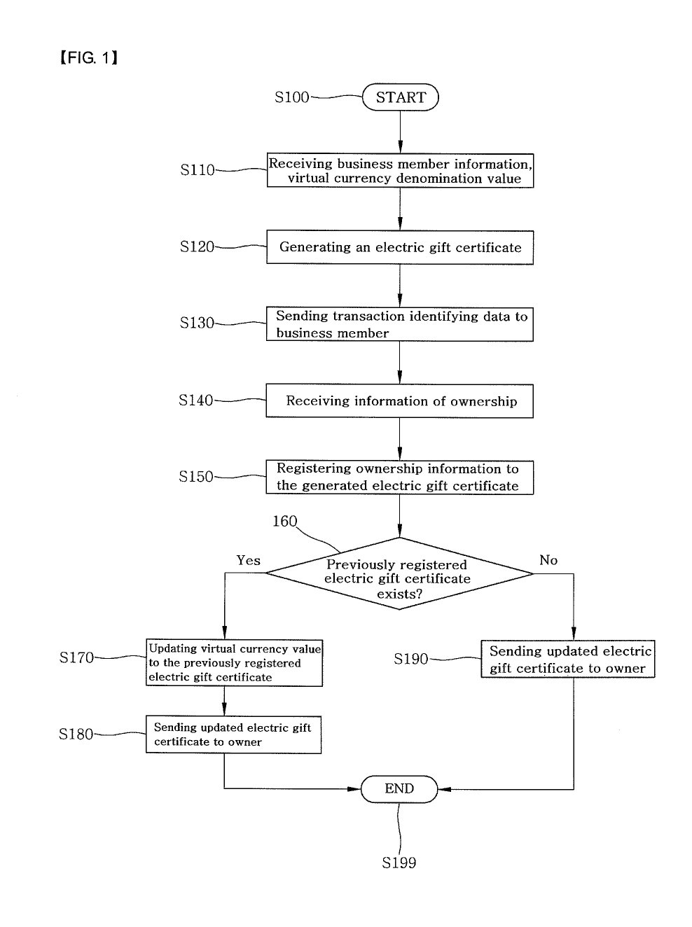

FIG. 1 shows the method of integrating on-line and off-line virtual currency into an electric gift certificate according to desirable embodiments of the present invention.

As desirable embodiments of the present invention, a method for integrating on-line virtual currency into an electric gift certificate will be described first.

There are example businesses providing on-line virtual currency, such as an internet book store, which deposits points according to buying history of a customer, a credit card company, which reserves points for credit card spending of a customer, or a game publisher, which accumulates points for game play hours of a gamer. Generally, these businesses provide their own management pages in their web sites for customers to spend and manage the points. Customers may facilitate the present invention to convert the points into more applicable electric gift certificates.

In order to convert one's own points to electric gift certificates, the customer member activates a button, such as “buying electric gift certificates with points” button to effectuate a buy event, on a screen, which is provided by the business member (S100). At this moment, the business member should transfer information about the business member and reference denomination value of desired virtual currency to an electric gift certificate integrating server, which embodies the present invention (S110). The information about the business member is to identify the business member intending to issue electric gift certificates and may include identifying ID and identifying authentication number. The said reference denomination value of the virtual currency denotes nominal value of the electric gift certificate which the business member intends to issue, and further means an amount of money into which the points provided by the business member are converted based on the Won currency unit. The system for integrating on-line and off-line virtual currency into electric gift certificates according to one embodiment of the present invention provides an API (Application Programming Interface) type communication module in order to facilitate communication of the business member with respect to the electric gift certificate integrating server. Through the API, the business member transmits the information of the business member and the reference denomination value to the electric gift certificate integrating system. In one embodiment of the present invention, XML (Extensible markup language) or SIP (Session Initiation Protocol) Protocol may be utilized for structurally transferring those text data.

After receiving the identifying information of the business member and the reference denomination value, an electric gift certificate manager 208 generates an electric gift certificate equivalent to the reference denomination value and stores the electric gift certificate at an electric gift certificate storage 210 (S120). At this time, a unique identification number of the generated electric gift certificate is transferred to the business member by a business member information interface 202 (S130), and then the business member can the unique identification number for managing and tracking the transaction. The unique identification number should be a number that is capable of uniquely identifying the electric gift certificate stored in the electric gift certificate storage 210, and may be implemented as an index of the electric gift certificate data in the electric gift certificate storage or a serial number of the electric gift certificate.

Identification number of an owner of the points or the virtual currency is transferred to the electric gift certificate integrating system as an identification number of an owner who is going to receive the electric gift certificate (S140). For this, the business member may send an electric mail address or mobile terminal identification number as the identification number of the owner of the virtual currency, in reference to the its own member database, while the customer member also is able to directly input his/her identification number into an input form provided by the business member to be sent. The ownership identification number transferred through an ownership information interface 204 may be record onto the electric gift certificate data which have been generated and stored at the electric gift certificate storage (S150).

The generated electric gift certificate may be transferred to a mobile communication terminal corresponding to the e-mail address or the mobile terminal identification number, which is received as the identification number of the owner, through an electric gift certificate sender 206. In this case, the electric gift certificate sender may be connected to the Internet for transferring the electric gift certificate via e-mail, or to an MMS (Multimedia Message Service) server or an SMS (Short Message Service) server for transferring the electric gift certificate via a mobile communication system.

In another embodiment of the present invention, the generated electric gift certificate may be issued in a fashion of updating an already existing electric gift certificate. First, it is determined whether another electric gift certificate owned by the owner is already registered or not (S160). If no other electric gift certificate owned by the owner exists, then the generated electric gift certificate is transferred to the owner, as described above (S190). If otherwise, the nominal value of the already registered electric gift certificate is updated adding value of the newly generated electric gift certificate (S170), and then the updated electric gift certificate is transferred to the owner (S180). In this case, the generated electric gift certificate may be flagged OFF, in order not to issue duplicated and then be stored at the electric gift certificate storage for using it as a log of the transaction, or may be just removed.

The business member, such as internet bookstores, credit card companies, game publishers, offering the on-line virtual currency, may allow the owners of the points to choose whether to use the points, to change the points to the electric gift certificate, to reserve the electric gift certificate, or to transfer the electric gift certificate to the mobile terminal, while the business member may interact to the electric gift certificate integrating system according to the invention through API etc. in order to implement functions in accordance with choice of the owner.

In cases of business members, distributing off-line virtual currency, embodiments as below may be contrived.

A business member which issues off-line virtual currency note transfers the information of the business member and the reference denomination value to the electric gift certificate integrating system (S110). The electric gift certificate integrating system generates an electric gift certificate based on the information of the business member and the reference denomination value (S120), and then transfers a unique identification number to the business member (S130). Thus, the off-line virtual currency note can be matched to the generated electric gift certificate, one-to-one. After that, when the owner input the information of the owner and the unique identification number into the electric gift certificate integrating system, the electric gift certificate can be coupled to the owner and be managed accordingly. In other words, the electric gift certificate integrating system receives from an owner a serial number or a unique identification number of an off-line virtual currency note, which comes into his ownership, along with his identification number (S140), registers the owner information with respect to the corresponding electric gift certificate data in reference to the serial number of the unique identification number of the virtual currency (S150), and then issues the electric gift certificate to the owner. In this case, if there already exists an electric gift certificate owned by the owner, the nominal value of the existing electric gift certificate is updated by adding the nominal value of the newly issued electric gift certificate (S170), and then the updated electric gift certificate is transferred to the owner (S180). It is no need to say that the generated electric gift certificate may be flagged OFF, in order not to issue duplicated and then be stored at the electric gift certificate storage for using it as a log of the transaction, or may be just removed.

As one embodiment according to the present invention, the electric gift certificate integrating system may be implemented in a fashion that the business member issues the electric gift certificate and transfers the electric gift certificate to the owner of the electric gift certificate. The business member which intends to issue electric gift certificates to its own customers may communicate with the electric gift certificate integrating system to send the identifying ID, identifying authentication number of the business member, and the reference denomination value of the virtual currency, and then the system may generate electric gift certificates correspondingly. The system may receive identification number of customers from the business member for information of the customers for whom the electric gift certificates are to be issued, and the received information is written along with the generated electric gift certificate data. The identification number of customer includes information capable of discriminating respective persons, desirably including mobile communication terminal identification number or e-mail address, etc. The generated electric gift certificate may include a serial number or bar code, etc., necessary for using the electric gift certificate, which can be transferred via e-mail in reference to the identification number of the customer for whom the electric gift certificate is issued, or via an MMS server or an SMS server to the mobile communication terminal. In this case, when the business member has an intention to issue a certain amount of electric gift certificate for its customer, it is as good as to say that the customer owns the certain amount of the virtual currency, and therefore the reference denomination value of the virtual currency matches the nominal value of the electric gift certificate which the business member intends to issue.

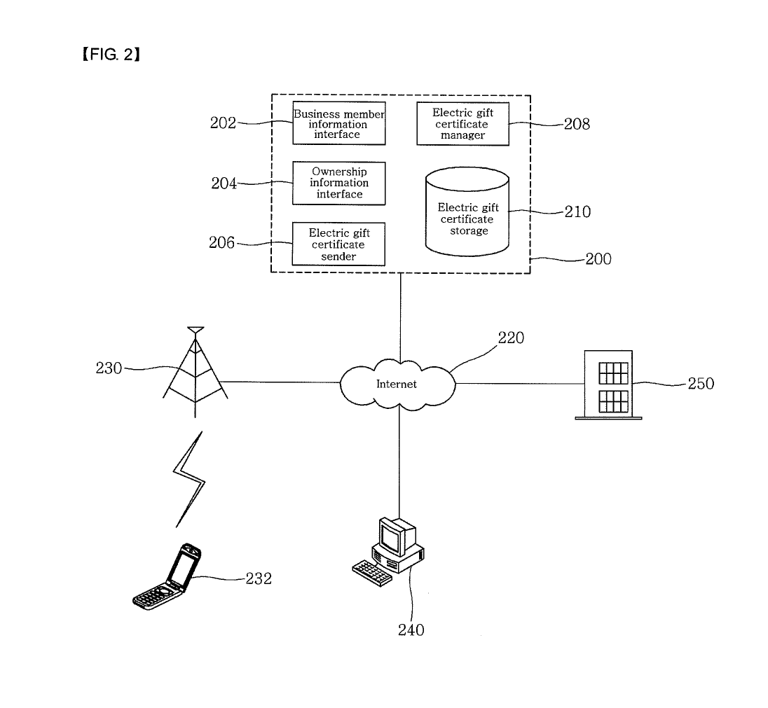

FIG. 2 is a block diagram illustrating a system for integrating on-line and off-line virtual currency into an electric gift certificate according to embodiments of the present invention.

A system for integrating on-line and off-line virtual currency into electric gift certificates according to the desirable embodiments of the present invention may include a business member information interface 202 for receiving in communication with a business member issuing virtual currency an identifying ID, an identifying authentication number of the business member, and a reference denomination value of the virtual currency, and sending a unique identification number of a generated electric gift certificate, an ownership information interface 204 for receiving identification information of an owner of the virtual currency, an electric gift certificate manager 208 for generating and updating the electric gift certificate based on the information received by the business member information interface and the ownership information interface, an electric gift certificate storage 210 for storing the electric gift certificate which is generated and updated by the electric gift certificate manager, and an electric gift certificate sender 206 for transferring the electric gift certificate to the owner of the electric gift certificate.

The business member information interface 202 may allow the external service-providing business members to easily access to, being provided with API type modules for external connection, as similar as the ownership information interface 204, and further may be provided as an input form into which a user logging in the system implementing the present invention may directly input information.

The electric gift certificate manager 208 is a module that may generate, update and remove data concerning electric gift certificates, at the electric gift certificate storage 210 for storing the electric gift certificates.

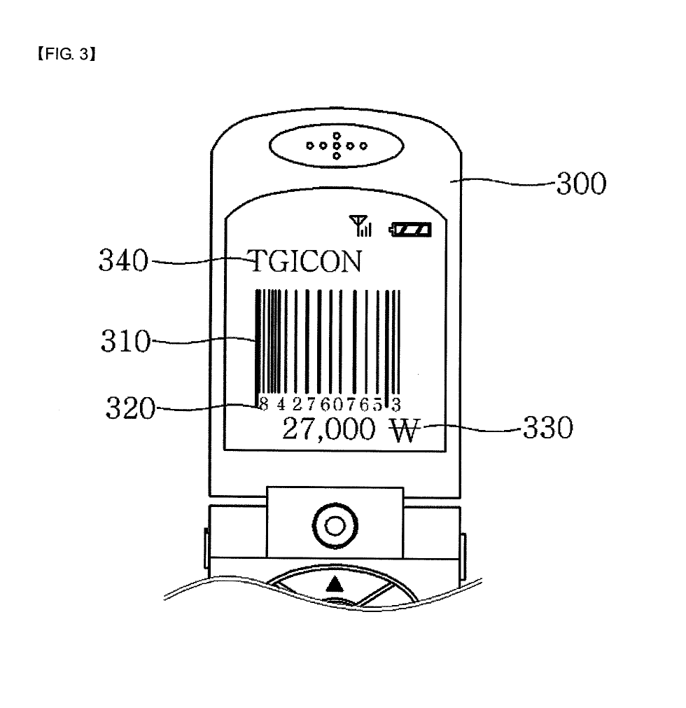

The electric gift certificate sender 206 is a module that configures an electric gift certificate from the electric gift certificate stored at the electric gift certificate storage 210, and manages transmission of electric gift certificate to the owner of the electric gift certificate. For configuration of the electric gift certificate, description follows as below referring to FIG. 3.

A system 250 of the business member providing the virtual currency is connected to the electric gift certificate integrating server 200 via Internet 220.

FIG. 3 is a conceptual figure illustrating an electric gift certificate, into which on-line and off-line virtual currency are integrate, shown on a mobile telecommunication terminal.

The electric gift certificate according to one embodiment of the present invention may be transferred as multimedia data via an MMS server and include a title 340 of the electric gift certificate, bar code 310 readable by a barcode reader, a serial number 320, a nominal value 330 of the electric gift certificate, shown on a mobile communication terminal 300.

In another embodiment of the present invention, the electric gift certificate may be transferred through an SMS server as a short message, including a title of the electric gift certificate, a serial number, and a nominal value of the electric gift certificate, present on a mobile terminal.

The electric gift certificate is configured by the electric gift certificate sender 206 based on the data stored at the electric gift certificate storage 210, so as to be transferred by a mobile communication system 230.

The above-implemented system for integrating on-line and off-line virtual currency into electric gift certificates may be utilized for payment transactions through on-line shopping sites linked to the present system or POS terminals, etc. of off-line member shop. In other words, payment request to the electric gift certificate integrating system may be asked for by the way that the owner inputs a serial number of his own electric gift certificate in case of on-line shopping sites, etc., and by the way that the owner offers a bar code of his electric gift certificate stored within his mobile terminal to be read at an off-line member shop. The electric gift certificate integrating system may process the payment request and manage the electric gift certificate.

The scope of the present invention is not to be limited within the above-described embodiments and is defined by what is described in claims. It is explicit for those skilled in the art of the present invention to intend various modifications and changes within the scope of the claims.

1. A method for integrating on-line and off-line virtual currency into electric gift certificates comprising:
(a) receiving an identifying ID and an identifying authentication number of a business member providing virtual currency, and a reference denomination value of the virtual currency;
(b) generating an electric gift certificate having the reference denomination value of the virtual currency;
(c) sending a unique identification number of the generated electric gift certificate;
(d) receiving a identification number of an owner to whom the electric gift certificate is to be sent;
(e) recording the identification number of the owner of the electric gift certificate and sending the generated electric gift certificate to the owner of the electric gift certificate.

2. The method of claim 1, wherein the step (d) comprises:
receiving the identification number of the owner to whom the electric gift certificate is to be sent and the unique identification number of the electric gift certificate.

3. The method of claim 1, wherein, when the electric gift certificate is previously registered with the identification number of the owner to whom the electric gift certificate is to be sent,
the step (e) comprises:
updating a nominal value of the previously registered electric gift certificate with a value adding up a nominal value of the generated electric gift certificate, and sending the updated electric gift certificate to the owner of the electric gift certificate.

4. A system for integrating on-line and off-line virtual currency into electric gift certificates comprising:
a business member information interface for receiving an identifying ID and an identifying authentication number of a business member providing virtual currency, and a reference denomination value of the virtual currency;
an ownership information interface for receiving a identification information of an owner to whom an electric gift certificate is to be sent;
an electric gift certificate manager for generating and updating the electric gift certificate having the reference denomination value of the virtual currency;
an electric gift certificate storage for storing the generated and updated by the electric gift certificate manager; and
an electric gift certificate sender for sending the electric gift certificate to the owner of the electric gift certificate.

5. The system of claim 4, wherein the electric gift certificate comprises at least one among a serial number, a bar code, or an authentication number.

6. The system of claim 4, wherein the identification information of the owner comprises a mobile communication identification number of the owner, and
the electric gift certificate sender sends the electric gift certificate to a mobile communication terminal corresponding to the mobile communication identification number of the owner in connection with an MMS server or an SMS server of a mobile communication system.

7. The system of claim 4, wherein the business member information interface and the ownership information interface are externally presented as API type of modules.
